(19) United States
(12) Patent Application Publication
(10) Pub. No.: US 2026/0329216 A1
(43) Pub. Date: Oct. 22, 2026

(54) STRUCTURE FOR OPENING AND CLOSING SENSOR UNIT FOR IMAGE QUALITY CALIBRATION

(71) Applicant: Hewlett-Packard Development Company, L.P., Spring, TX (US)

(72) Inventors: Changwoo Lee, Seongnam Si (KR); DaeLim Shin, Seongnam Si (KR); Hakkyum Kim, Seongnam Si (KR); Sooyong Kim, Seongnam Si (KR); Seungkyu Lee, Seongnam Si (KR)

(21) Appl. No.: 19/105,913

(22) PCT Filed: Jan. 30, 2023
(86) PCT No.: PCT/US2023/011834

§ 371 Date: Feb. 24, 2025

(30) Foreign Application Priority Data
Aug. 25, 2022 (KR) 10-2022-0106710

(51) Int. Cl. G03G 15/00; G03G 15/01

(52) U.S. Cl. CPC G03G 15/55; G03G 15/0136; G03G 15/5058; G03G 2215/00059; G03G 2215/00063; G03G 2215/0158

(57) ABSTRACT

A shutter device may include a shutter, a shutter link to move the shutter to a first position where an image quality calibration sensor is closed or a second position where the image quality calibration sensor is opened, a pusher to press the shutter link so that the shutter moves to the second position, and a power transmitting member to transmit a driving force provided inside an image forming apparatus to the pusher.

### BACKGROUND

An image forming apparatus forms an electrostatic latent image by scanning light to a rotating photoconductor through an exposure unit. The image forming apparatus forms a toner image on the surface of the photoconductor by supplying a toner to the photoconductor on which the electrostatic latent image is formed through a developing unit. The image forming apparatus forms an image on a print medium by transferring the toner image of the photoconductor to a transfer unit, transferring the toner image to the print medium again, and pressing and heating the image transferred to the print medium through a fixing unit.

### BRIEF DESCRIPTION OF DRAWINGS

FIG. 1A is a cross-sectional view schematically illustrating an example configuration of an image forming apparatus consistent with the disclosure.

FIG. 1B is a block diagram schematically illustrating an example configuration of an image forming apparatus consistent with the disclosure.

FIG. 2 is a perspective view illustrating an example mode switching unit switching a printing mode of a transfer belt consistent with the disclosure.

FIG. 3 is a view illustrating an example in which a sensor unit for auto color registration (ACR) correction is closed by a shutter device consistent with the disclosure.

FIG. 4 is a view illustrating an example in which a sensor unit for ACR correction is opened by a shutter device consistent with the disclosure.

FIG. 5 is a perspective view illustrating an example in which a shutter device of an image forming apparatus according to an example is disposed on a frame disposed inside a main body consistent with the disclosure.

FIGS. 6 and 7 are perspective views illustrating an example shutter device of an image forming apparatus consistent with the disclosure.

FIGS. 8 and 9 are views illustrating an example in which a sensor unit is closed by a shutter device of an image forming apparatus consistent with the disclosure.

FIGS. 10 and 11 are views illustrating an example in which a sensor unit is opened by a shutter device of an image forming apparatus consistent with the disclosure.

### DETAILED DESCRIPTION

Hereinafter, various implementations will be described in detail with reference to the drawings. The implementations described below may be modified and implemented in various different forms.

In the present specification, when a component is “connected” to another component, it includes not just a case where the component is directly connected to the other component but also a case where the component is connected to the other component with another component therebetween. In addition, when a component “includes” another component, it means that it may further include other components rather than excluding other components, unless otherwise stated.

In addition, the term “image forming apparatus” refers to an apparatus for printing print data generated by a terminal device, such as a computer, on a recording print medium. Examples of such an image forming apparatus include a copier, a printer, a facsimile, or a multi-function printer (MFP) that incorporates the functionality of a plurality of devices (e.g., a copier, a printer, a facsimile) in one device.

The examples described below are illustratively shown to help the understanding of the present disclosure, and the present disclosure may be implemented with various modifications different from the implementations described herein.

However, in the following description of the present disclosure, if it is determined that a detailed description of a related particular function or component may unnecessarily obscure the subject matter of the present disclosure, the detailed description and specific illustration thereof may be omitted. In addition, the accompanying drawings are not drawn to scale in order to help understanding of the disclosure, but dimensions of some components may be exaggerated.

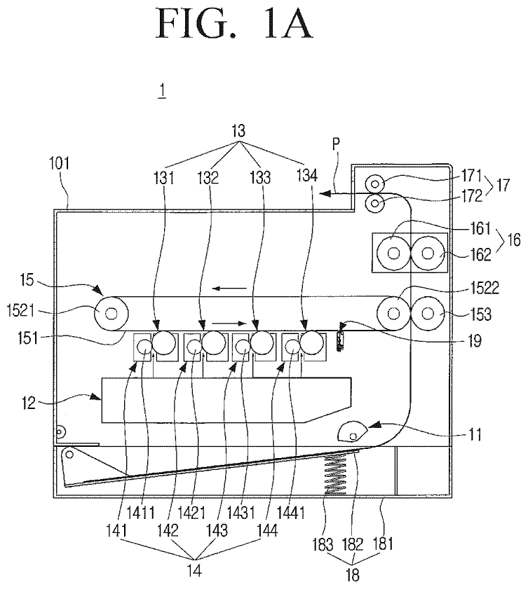

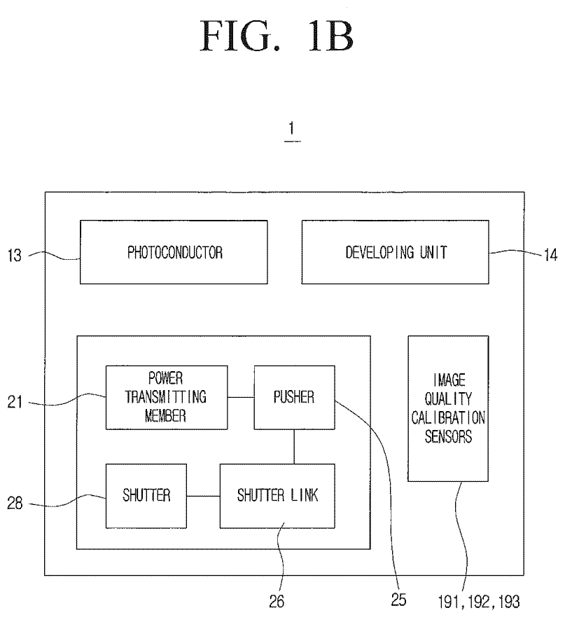

FIG. 1A is a cross-sectional view schematically illustrating an example configuration of an image forming apparatus consistent with the disclosure.

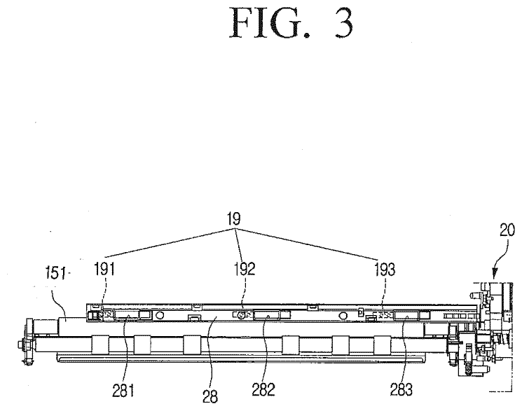

Referring to FIG. 1A, the image forming apparatus 1 according to an example may be implemented as a printer, a copier, a scanner, and a facsimile, and may be a multi-function peripheral (MFP) in which functions of the printer, the copier, the scanner, and the facsimile are complexly implemented through one device. As shown in FIG. 1A, the image forming apparatus 1 may include a main body 101 forming an exterior thereof, a paper feeding unit 11, an exposure unit 12, a photoconductor 13, a developing unit 14, a transfer unit 15, a fixing unit 16, a discharge unit 17, a cassette unit 18, a sensor unit 19, and a shutter device (e.g., 20 in FIGS. 3-6). According to an example, each of the photoconductor 13 and the developing unit 14 may be arranged in a single unit and may be arranged in four units according to the color of a toner, as shown in FIG. 1A.

The paper feeding unit 11 may pick up a print medium, such as paper on which an image is formed, and transport the print medium to a transporting path P inside the main body 101. The paper feeding unit 11 may pick up papers loaded in the cassette unit 18 one by one and put the paper into the transporting path P. The paper feeding unit 11 may include a pickup roller picking up papers one by one, and a plurality of transporting rollers disposed on the transporting path P.

The cassette unit 18 may include a cassette body 181 detachably coupled to a lower portion of the main body 101, a pickup plate 182 on which print media are loaded, and a pickup elastic body 183 elastically supporting the pickup plate 182. A plurality of print media loaded inside the cassette body 181 may be picked up one by one by the pickup roller of the paper feeding unit 11 in a state supported by the pickup plate 182.

In FIG. 1A, the single cassette unit 18 can be detachably coupled to the lower portion of the main body 101 as an example, but the cassette unit 18 may be arranged in a plurality of cassette units. The image forming apparatus 1 may further include a multipurpose tray coupled to a side surface or an upper portion of the main body 101 to supply a print medium into the main body 101.

The exposure unit 12 may form an electrostatic latent image on the surface of the photoconductor 13 by scanning light including image information to the photoconductor 13. The developing unit 14 may form a toner image by supplying a toner to the photoconductor 13 on which the electrostatic latent image is formed. The developing unit 14 may include first, second, third, and fourth developing units 141, 142, 143, and 144. The first, second, third, and fourth developing units 141, 142, 143, and 144 may respectively include toners of cyan (C, cyan), magenta (M, magenta), yellow (Y, yellow) and black (K, black) colors.

The photoconductor 13 may be implemented in the form of a photoconductor drum. The photoconductor 13 may include first, second, third, and fourth photoconductors 131, 132, 133, and 134 respectively corresponding to the first, second, third, and fourth developing units 141, 142, 143, and 144. First, second, third, and fourth charging rollers (not shown) respectively charging the first, second, third, and fourth photoconductors 131, 132, 133, and 134 may be disposed on outer circumferential surfaces of the first, second, third, and fourth photoconductors 131, 132, 133, and 134. The first, second, third, and fourth charging rollers may charge (e.g., uniformly charge) the surfaces of the rotating first, second, third, and fourth photoconductors 131, 132, 133, and 134 to a predetermined potential, respectively.

The exposure unit 12 may be disposed on lower sides of the first, second, third, and fourth photoconductors 131, 132, 133, and 134 and may scan the light including the image information to the charged first, second, third, and fourth photoconductors 131, 132, 133, and 134, thereby forming an electrostatic latent image on the outer circumferential surfaces of the first, second, third, and fourth photoconductors 131, 132, 133 and 134. The exposure unit 12 may scan the light including the image information of each toner for each color to the first, second, third, and fourth photoconductors 131, 132, 133, and 134.

The first, second, third, and fourth developing units 141, 142, 143, and 144 may respectively include first, second, third, and fourth developing rollers 1411, 1421, 1431, and 1441 facing the first, second, third, and fourth photoconductors 131, 132, 133 and 134. The first, second, third, and fourth developing rollers 1411, 1421, 1431, and 1441 may selectively contact the first, second, third, and fourth photoconductors 131, 132, 133 and 134 on which the electrostatic latent image is formed, respectively.

The first, second, third, and fourth developing rollers 1411, 1421, 1431, and 1441 may rotate in contact with the first, second, third, and fourth photoconductors 131, 132, 133 and 134 to move the toner of cyan (C), magenta (M), yellow (Y) and black (K) colors to the electrostatic latent image formed on the first, second, third, and fourth photoconductors 131, 132, 133 and 134. As a result, visible toner images of cyan (C), magenta (M), yellow (Y), and black (K) colors may be formed on the surfaces of the first, second, third, and fourth photoconductors 131, 132, 133 and 134.

The transfer unit 15 may include a transfer belt 151, first and second rotation rollers 1521 and 1522 rotating the transfer belt 151, and a transfer roller 153 facing the transfer belt 151 and forming a nip through which the print medium passes.

The first and second rotation rollers 1521 and 1522 may rotatably support the transfer belt 151. For example, the first rotating roller 1521 may maintain the tension of the transfer belt 151, and the second rotating roller 1522 may rotate through a separate driving unit to rotate the transfer belt 151. The transfer unit 15 may further include a plurality of rotation rollers in addition to the first and second rotation rollers 1521 and 1522.

The transfer belt 151 may rotate in contact with the first, second, third, and fourth photoconductors 131, 132, 133, and 134. In this case, the toner images with the first, second, third, and fourth photoconductors 131, 132, 133, and 134 may be sequentially transferred to the transfer belt 151.

For example, as the transfer belt 151 rotates counterclockwise with reference to FIG. 1A, the toner images of cyan (C), magenta (M), yellow (Y), and black (K) with the first, second, third, and fourth photoconductors 131, 132, 133, and 134 may be sequentially transferred to the transfer belt 151. As a result, a color toner image in which the toner images of cyan (C), magenta (M), yellow (Y), and black (K) overlap may be formed on the transfer belt 151. The color toner image formed on the transfer belt 151 may be transferred to the print medium passing between the transfer belt 151 and the transfer roller 153.

FIG. 1B is a block diagram schematically illustrating an example configuration of an image forming apparatus consistent with the disclosure.

Referring to FIG. 1B, the image forming apparatus 1 according to an example may include the photoconductor 13 on which an electrostatic latent image is formed, the developing unit 14 supplying a toner to the electrostatic latent image to form a toner image on printing paper, image quality calibration sensor 191, 192, and 193 detecting a mark of a transfer belt for color image quality calibration, and a shutter device opening and closing the image quality calibration sensor 191, 192, and 193. The shutter device may include a shutter 28, a shutter link 26 moving the shutter 28, a pusher 25 pressing the shutter link 26 in one direction, and a power transmitting member 21 transmitting power to drive the pusher 25.

The shutter 28 may selectively open and close the image quality calibration sensors 191, 192, and 193 in conjunction with the shutter link 26.

The shutter link 26 may move the shutter 28 to a first position for closing the image quality calibration sensors 191, 192, and 193 or a second position for opening the image quality calibration sensors 191, 192, and 193. The pusher 25 may press the shutter link 26 by receiving power for mode switching from the transfer unit so that the shutter 28 moves to the second position.

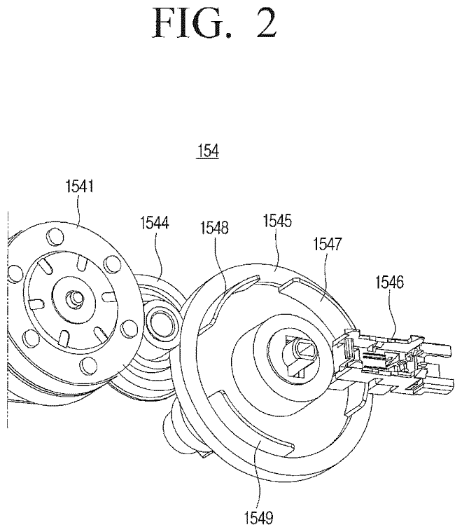

The power transmitting member 21 may transmit a driving force provided from the inside of the image forming apparatus 1 to the pusher 25. The power transmitting member 21 may receive power for driving the pusher 25 from a mode switching motor (e.g., 1541 of FIG. 2) of a mode switching unit (e.g., 154 of FIG. 2), but is not limited thereto, and may receive power from one of motors disposed inside the image forming apparatus 1 and generating power.

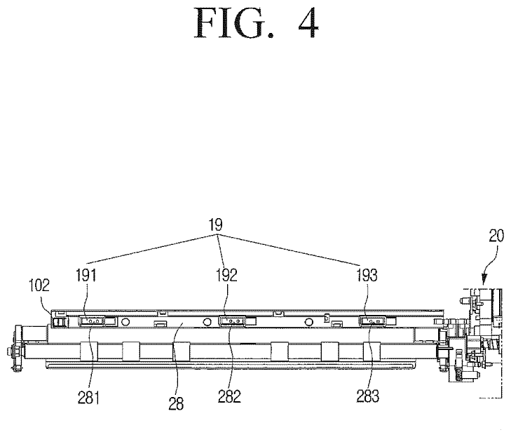

FIG. 2 is a perspective view illustrating an example mode switching unit switching a printing mode of a transfer belt consistent with the disclosure. FIG. 3 is a view illustrating an example in which a sensor unit for auto ACR correction is closed by a shutter device consistent with the disclosure. FIG. 4 is a view illustrating an example in which a sensor unit for ACR correction is opened by a shutter device consistent with the disclosure.

Referring to FIG. 2, the transfer unit 15 may include a mode switching unit 154 switching the transfer belt 151 to one of a color mode, a mono mode, which are printing modes, and an initial mode. For example, the color mode may be a mode where a color image is printed on a print medium, the mono mode may be a mode where a black and white image is printed, and the initial mode may be a print standby/off state or a mode where a toner is replaced.

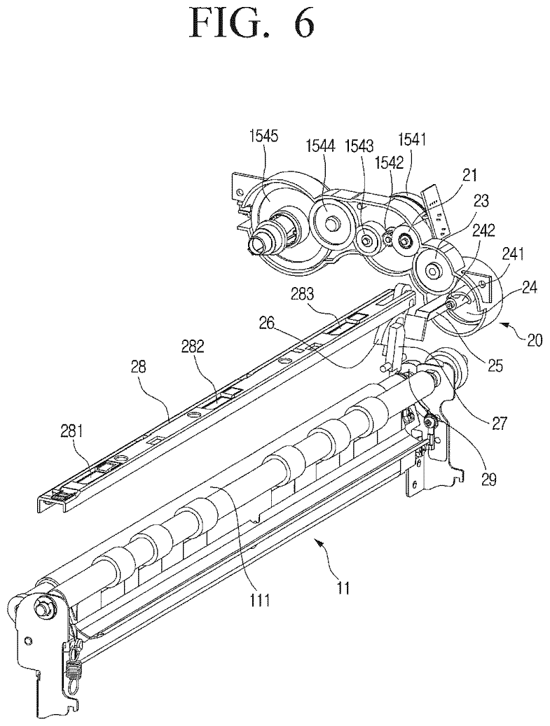

The mode switching unit 154 may include a mode switching motor 1541 capable of forward rotation and reverse rotation driving, a plurality of power transmission gears 1543 and 1544 in FIG. 6, a mode switching gear 1545 rotating by receiving the driving force of the mode switching motor 1541 from the plurality of power transmission gears 1543 and 1544, and a mode detection sensor 1546. The mode switching gear 1545 may include first, second, and third ribs 1547, 1548, and 1549 arranged at intervals in a circumferential direction of the mode switching gear 1545 on one surface. The first, second, and third ribs 1547, 1548, and 1549 may be detected by the mode detection sensor 1546 when the mode switching gear 1545 rotates.

For example, when a controller (not shown) drives the mode switching motor 1541 to set the transfer belt 151 to the color mode, the mode switching gear 1545 rotates at a preset angle. In this example, when receiving a detection signal of the first rib 1547 from the mode detection sensor 1546, the controller may determine that the transfer belt 151 is set to the color mode. In this way, the second rib 1548 may correspond to the mono mode, and the third rib 1549 may correspond to the initial mode.

The fixing unit 16 may include first and second fixing rollers 161 and 162. The print medium onto which a color toner image is transferred is pressed and heated while passing between the rotating first and second fixing rollers 161 and 162 so that the color toner image may be fixed.

The discharge unit 17 may include first and second discharge rollers 171 and 172. The print medium on which the color toner image is fixed by the fixing unit 16 may be discharged to the outside of the image forming apparatus 1 by passing between the rotating first and second discharge rollers 171 and 172.

The sensor unit 19 may detect a registration mark transferred to the transfer belt 151 to perform an image quality calibration function, for example, Auto Color Registration (ACR) correction. The sensor unit 19 may be disposed adjacent to the transfer belt 151 and may be disposed downstream compared to the fourth photoconductor 134 with respect to a rotation direction of the transfer belt 151.

Referring to FIGS. 3 and 4, the sensor unit 19 may include a plurality of sensors 191, 192, and 193 which are image quality calibration sensors. The plurality of sensors 191, 192, and 193 may be arranged at intervals in a structure 102 disposed adjacent to the transfer belt 151. The plurality of sensors 191, 192, and 193 each may be, for example, an image sensor such as an optical sensor, a complementary metal oxide semiconductor (CMOS) sensor, or a charge coupled device (CCD) sensor.

When a developing unit is replaced, when the image forming apparatus 1 continuously (e.g., near-continuously) performs a large amount of printing, or when the image forming apparatus 1 has not operated for a particular period of time, a color registration of the color toner image output by the image forming apparatus 1 may not match. In such an example, since toners of respective colors overlap as they shift from desired positions, quality deterioration such as blurring of a boundary part of the color toner image may occur.

For ACR correction, the image forming apparatus 1 may transfer the registration mark to the transfer belt 151 through the first, second, and third photoconductors 131, 132, and 133, and the first, second, and third developing units 141, 142, and 143. In an ACR correction mode, the controller may control a paper feed roller 111 of the paper feed unit 11 such that it does not rotate, so that the print medium is not fed from the cassette unit 18.

The sensor unit 19 may detect the registration mark transferred to the transfer belt 151. For example, a toner image of cyan (C), magenta (M), and yellow (Y) may be displayed on the registration mark independently or overlappingly according to preset width and length.

The controller may determine whether a plurality of marks formed on the transfer belt 151 do not match a particular standard by detecting the width, length, etc. of a plurality of registration marks through the plurality of sensors 191, 192, and 193 of the sensor unit 19. When each mark formed on the transfer belt 151 corresponds to a preset ACR correction condition, the controller may control the exposure unit 12, the photoconductor 13, the developing unit 14, or the transfer unit 15 to perform correction on the color toner image formed on the transfer belt 151 and the print medium.

The sensor unit 19 may be closed by the shutter 28 of the shutter device 20 as shown in FIG. 3 when not in the ACR correction mode. The sensor unit 19 may be opened by the shutter 28 of the shutter device 20 as shown in FIG. 4 in the ACR correction mode. Accordingly, the sensor unit 19 may be prevented and/or reduced from being contaminated by the toner scattering in the main body 101 or the share of the print medium.

Hereinafter, the shutter device 20 opening and closing the sensor unit 19 will be described with reference to the drawings.

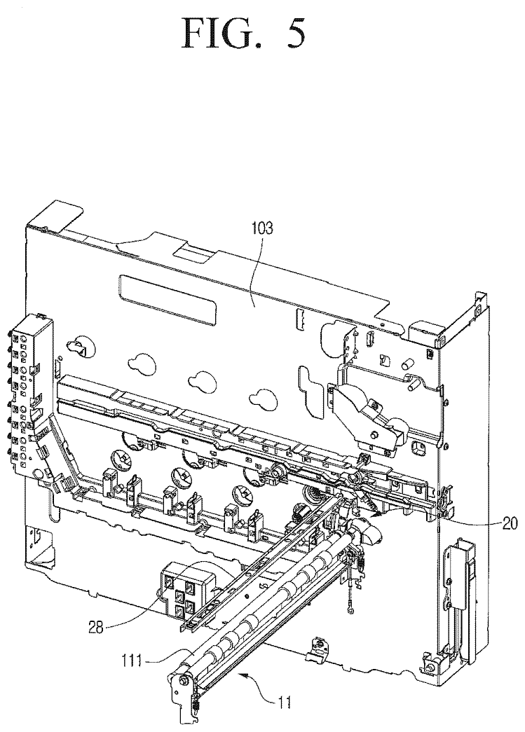

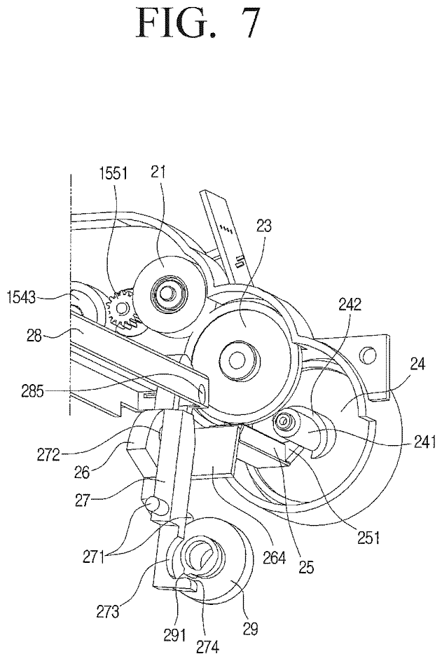

FIG. 5 is a perspective view illustrating an example in which a shutter device of an image forming apparatus according to an example is disposed on a frame disposed inside a main body consistent with the disclosure. FIGS. 6 and 7 are perspective views illustrating an example shutter device of an image forming apparatus consistent with the disclosure.

Referring to FIG. 5, the shutter device 20 may be disposed on a frame 103 disposed approximately vertically inside the main body 101. The paper feeding unit 11 may be disposed on one side of the frame 103 approximately horizontally. The shutter 28 of the shutter device 20 may be disposed on an upper side of the paper feeding unit 11 and may be disposed approximately parallel to the paper feeding unit 11.

The shutter device 20 may move the shutter 28 from a first position to a second position in conjunction with the rotation of the paper feeding roller 111 of the paper feeding unit 11. For example, the first position may be a position where the shutter 28 closes the plurality of sensors 191, 192, and 193 of the sensor unit 19 as shown in FIG. 3. The second position may be a position where the plurality of sensors 191, 192, and 193 of the sensor unit 19 are opened as shown in FIG. 4.

Referring to FIGS. 6 and 7, the shutter device 20 may include gear chains 21, 23, and 24 which are power transmitting members receiving power from the mode switching motor 1541, a pusher 25 driven by the gear chains 21, 23 and 24 in a linear direction, a shutter link 26 pressed by the pusher 25, and a shutter 28 connected to the shutter link. The shutter device 20 may include a stopper 27 capable of locking the shutter link 26 and an unlocking member 29 capable of unlocking the shutter link 26 by operating the stopper 27.

The gear chains 21, 23, and 24 may include a first connection gear 21 connected to a gear (e.g., 1542 in FIGS. 6, 1551 in FIG. 7) coupled to a drive shaft of the mode switching motor 1541, a second connection gear 23 connected to the first connection gear 21, and a final gear 24 coupled to the second connection gear 23. A reduction ratio from the mode switching motor 1541 to the final gear 24 disposed at the distal end may be the same or an integer multiple so that when the transfer belt 151 is converted to the color mode by the mode switching unit 154, the plurality of sensors 191, 192, and 193 of the sensor unit 19 may be opened by the shutter 28.

The final gear 24 may include a shaft protrusion 241 protruding toward the side on which the shutter link 26 is disposed. A cam inclined surface 242 may be formed on an outer periphery of the shaft protrusion 241 in a spiral direction. The final gear 24 may move the cam-contacted pusher 25 toward the shutter link 26 when, for example, rotating clockwise with reference to FIG. 7.

The pusher 25 may be disposed between the final gear 24 and the shutter link 26. A cam protrusion 251 in cam contact with the cam inclined surface 242 of the final gear 24 may be formed on a rear end portion of the pusher 25. The pusher 25 may be pulled toward the final gear 24 by a first elastic member (not shown) and maintained spaced apart from the shutter link 26. For example, the first elastic member pulling the pusher 25 toward the final gear 24 may be a coil spring.

The pusher 25 may rotate the shutter link 26 counterclockwise while the cam protrusion 251 of the pusher 25 is in cam contact with the cam inclined surface of the final gear 24 as the final gear 24 rotates. As the cam inclined surface 242 of the final gear 24 is formed in a spiral shape, when the final gear 24 rotates at a predetermined angle or more, cam contact between the cam protrusion 251 of the pusher 25 and the cam inclined surface 242 of the final gear 24 may be released. In this example, the pusher 25 may return to the original position by moving toward the final gear 24 by the elastic force of the first elastic member.

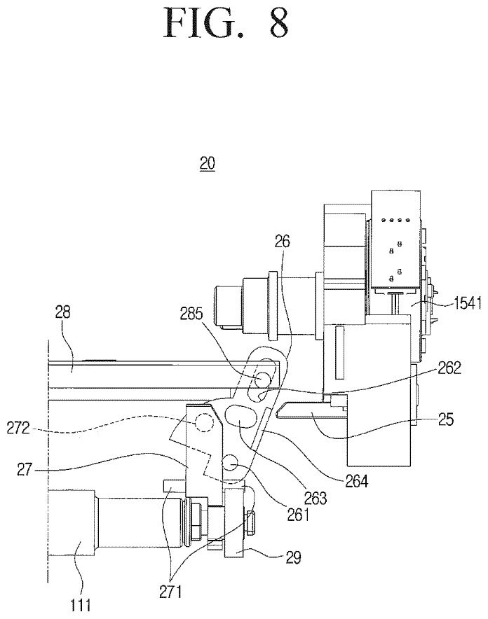

One end of the shutter link 26 may be hingedly connected to the shutter 28, and the other end thereof may be rotatably connected to a predetermined structure (not shown) inside the main body 101. For example, the shutter link 26 may move the shutter 28 from the first position (e.g., a sensor closed position, see FIG. 3) to the second position (e.g., a sensor opened position, see FIG. 4) while rotating by a predetermined angle counterclockwise with respect to FIG. 8 by the pusher 25. The shutter link 26 may move the shutter 28 from the second position (e.g., the sensor opened position) to the first position (e.g., the sensor closed position) while rotating by a predetermined angle clockwise with respect to FIG. 8 when locking by the stopper 27 is released.

A first rotation shaft 261 may be formed at a lower portion of the shutter link 26 to be approximately orthogonal to a direction in which the paper feed roller is disposed. The shutter link 26 may rotate by a predetermined angle clockwise or counterclockwise with respect to the first rotation shaft 261. A long hole 262 into which a hinge shaft 285 coupled to one end portion of the shutter 28 is slidably inserted may be formed in the upper portion of the shutter link 26. A locking groove 263 into which a locking protrusion 272 of the stopper 27 can be detachably inserted may be formed in the central portion of the shutter link 26.

An extension portion 264 that may be pressed by the pusher 25 may be formed in the shutter link 26. The extension portion 264 of the shutter link 26 may protrude a predetermined length from the side end of the central portion of the shutter link 26 to face the pusher 25.

The stopper 27 may lock or unlock the shutter link 26. When the stopper 27 locks the shutter link 26 during ACR correction, the shutter 28 may maintain the second position to open the plurality of sensors 191, 192, and 193.

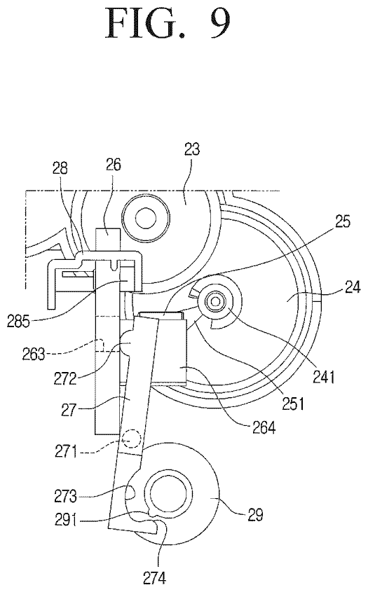

The stopper 27 may rotate in a direction approximately perpendicular to the first rotation shaft 261 on which the shutter link 26 rotates. In such an example, a second rotation shaft 271 may be formed approximately in the central portion of the stopper 27. The stopper 27 may rotate clockwise or counterclockwise with respect to the second rotation shaft 271. The stopper 27 may be elastically supported to rotate counterclockwise with reference to FIG. 9 by a second elastic member (not shown). The second elastic member providing the elastic force to the stopper 27 may be, for example, a torsion spring coupled to the second rotation shaft 271 of the stopper 27.

A locking protrusion 272 may be formed on one side surface of the stopper 27 facing the shutter link 26. The locking protrusion 272 of the stopper 27 may protrude in an approximately hemispherical shape so as to be detachably inserted into the locking groove 263 of the shutter link 26.

A groove 273 in an approximately arc shape may be formed in the lower portion of the stopper 27. The groove 273 of the stopper 27 may be located outside a rotating trajectory of a pressing protrusion 291 of the unlocking member 29 when the unlocking member 29 rotates. In such an example, the pressing protrusion 291 of the unlocking member 29 may not interfere with the stopper 27.

A locking protrusion 274 may be formed on a point where the groove 273 of the stopper 27 ends, for example, on the lowermost end of the stopper 27. The locking protrusion 274 of the stopper 27 may be located inside the rotating trajectory of the pressing protrusion 291 of the unlocking member 29 in a state where the stopper 27 locks the shutter link 26. In this case, the locking protrusion 274 of the stopper 27 may be pressed by the pressing protrusion 291 of the unlocking member 29 that rotates counterclockwise with reference to FIG. 9. Accordingly, the stopper 27 may rotate clockwise with reference to FIG. 9 to release the locking of the shutter link 26.

The shutter 28 may be disposed in a direction in which the plurality of sensors 191, 192, and 193 are arranged to open or close the plurality of sensors 191, 192, and 193 of the sensor unit 19. In the shutter 28, a plurality of openings 281, 282, and 283 may be formed by the same or similar intervals as those by which the plurality of sensors 191, 192, and 193 are disposed. The shutter 27 may be pulled from the second position (e.g., the sensor opened position) to the first position (e.g., the sensor closed position) by a third elastic member (not shown). The shutter 28 may maintain the first position by the elastic force of the third elastic member.

The plurality of openings 281, 282, 283 of the shutter 28 may be disposed at positions corresponding to the plurality of sensors 191, 192, and 193 respectively when the shutter 28 is in the second position (e.g., the sensor opened position). In this example, the plurality of sensors 191, 192, and 193 may detect corresponding registration marks transferred to the transfer belt 151. When the shutter 28 is in the first position (e.g., the sensor closed position), the plurality of openings 281, 282, and 283 of the shutter 28 may be located at different positions from positions of the corresponding plurality of sensors 191, 192, and 193. In this example, as the plurality of sensors 191, 192, and 193 are closed by the shutter 28, the plurality of sensors 191, 192, and 193 may not be contaminated by a toner scattered in the main body 101 or a share of the print medium.

The unlocking member 29 is coupled to one end of the paper feed roller 111 and may rotate together with the paper feed roller 111. The unlocking member 29 may unlock the shutter link 26 locked by the stopper 27. The unlocking member 29 may be coupled to one end of the paper feed roller 111 to rotate together with the paper feed roller 111.

The pressing protrusion 291 may be formed on the unlocking member 29 at a position corresponding to the groove 273 of the stopper 27. In some examples, the pressing protrusion 291 of the unlocking member 29 may rotate without interfering with the locking protrusion 274 of the stopper 27 in a state where the stopper 27 unlocks the shutter link 26. The pressing protrusion 291 of the unlocking member 29 may interfere with the locking protrusion 274 of the stopper 27 in a state where the stopper 27 locks the shutter link 26. In such an example, when the locking protrusion 274 of the stopper 27 is pressed by the pressing protrusion 291 of the rotating unlocking member 29, the stopper 27 may rotate to release the locking of the shutter link 26.

Hereinafter, a state where the plurality of sensors 191, 192, and 193 of the sensor unit 19 are closed by the shutter 28 of the shutter device 20 will be described with reference to the drawings.

FIGS. 8 and 9 are views illustrating an example in which a sensor unit is closed by a shutter device of an image forming apparatus consistent with the disclosure.

Referring to FIGS. 8 and 9, the shutter device 20 may close the plurality of sensors 191, 192, and 193 of the sensor unit 19 by moving the shutter 28 to a first position after ACR correction is completed (e.g., see FIG. 3). For example, when the transfer belt (e.g., the transfer belt 151 of FIG. 1) is switched from an ACR correction mode to a print mode (e.g., a color mode or a mono mode), the paper feed roller 111 of the paper feed unit 11 may rotate to feed a print medium. When the transfer belt is switched from the ACR correction mode to an initial mode, the paper feed roller 111 of the paper feed unit 11 may be stopped so as not to feed the print medium.

In this way, the states of the pusher 25 of the shutter device 20, the shutter link 26, the stopper 27, and the unlocking member 29 when the shutter 28 of the shutter device 20 closes the plurality of sensors 191, 192, and 193 of the sensor unit 19 will be described.

The pusher 25 may be pulled in a direction away from the shutter link 26 (e.g., a direction from left to right with reference to FIG. 8) by a first elastic member. Accordingly, the pusher 25 may be spaced apart from the extension portion 264 of the shutter link 26 and may not apply pressure to the shutter link 26.

The shutter 28 may be pulled toward a gear chain by a third elastic member and moved to the first position where the plurality of sensors 191, 192, and 193 of the sensor unit 19 are closed. As the shutter 28 moves to the first position, the shutter link 26 may maintain a state rotated by a predetermined angle clockwise with reference to FIG. 8 with respect to the first rotation axis 261 of the shutter link 26. In such an example, the shutter link 26 may be in a state where locking by the stopper 27 is released.

In this way, in the state where the shutter 28 closes the plurality of sensors 191, 192, and 193 of the sensor unit 19, as shown in FIG. 9, when the pressing protrusion 291 of the unlocking member 29 rotates, the pressing protrusion 291 may not interfere with the locking protrusion 274 of the stopper 27. For example, the plurality of sensors 191, 192, and 193 may be closed by the shutter 28 in a print mode, a print standby mode, or a state where the image forming apparatus 1 is turned off, other than the ACR correction mode.

The shutter 28 may open the sensor unit 19 in the ACR correction mode. The ACR correction mode may be set to correspond to a partial rotation period of the mode switching gear 1545. For example, as the mode switching gear 1545 rotates by driving the mode switching motor 1541, the mono mode may be switched to the color mode. In this case, the shutter 28 may be moved from the first position to the second position to open the plurality of sensors 191, 192, and 193 of the sensor unit 19. In addition, the shutter 28 may maintain a state where the plurality of sensors 191, 192, and 193 of the sensor unit 19 are opened while the mode switching gear 1545 rotates and is set to the color mode.

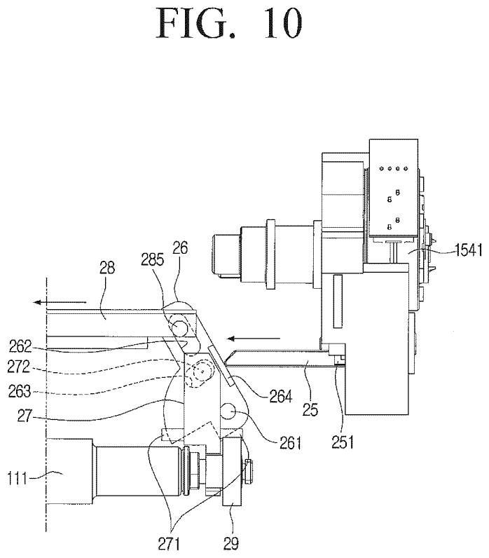

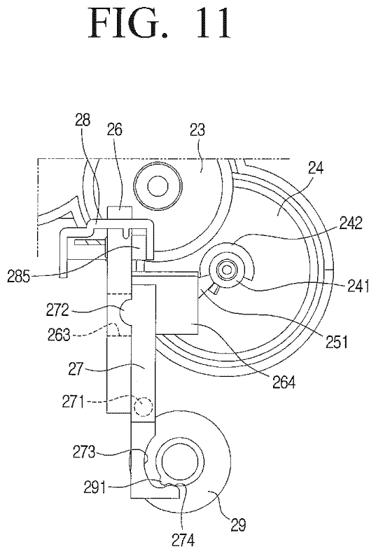

Hereinafter, an operation in which the shutter 20 of the shutter device 20 moves from the first position to the second position to open the plurality of sensors 191, 192, and 193 of the sensor unit 19 will be described with reference to the drawings. FIGS. 10 and 11 are views illustrating an example in which a sensor unit is opened by a shutter device of an image forming apparatus consistent with the disclosure.

Referring to FIG. 10, when the mode switching motor 1541 is driven, the gear chains 21, 23, and 24 may transmit the driving force of the mode switching motor 1541 to the pusher 25. For example, as the final gear 24 rotates, the cam protrusion 251 of the pusher 25 may be in cam contact with the cam inclined surface 242 of the final gear 24. The pusher 25 may move toward the shutter link 26 to press the extension portion 264 of the shutter link 26 from right to left.

The shutter link 26 may rotate counterclockwise with respect to the first rotation shaft 261 as pressed by the pusher 25. The shutter 28 may move from the first position to the second position by rotation of the shutter link 26. Accordingly, when the plurality of openings 281, 282, and 283 of the shutter 28 come to positions corresponding to the plurality of sensors 191, 192, and 193, the plurality of sensors 191, 192, and 193 may be opened.

Referring to FIG. 11, the stopper 27 may be disposed while being pulled toward the shutter link 26 by a second elastic member. For example, when the shutter link 26 rotates counterclockwise and the plurality of openings 281, 282, and 283 of the shutter 28 come to the positions corresponding to the plurality of sensors 191, 192, and 193, the locking groove 263 of the shutter link 26 may come to a position corresponding to the locking protrusion 272 of the stopper 27. In this example, the locking protrusion 272 of the stopper 27 may be inserted into the locking groove 263 of the shutter link 26.

When the shutter link 26 is locked by the stopper 27, the plurality of openings 281, 282, and 283 of the shutter 28 may maintain a state where the plurality of sensors 191, 192, and 193 are opened.

As a cam contact between the cam protrusion 251 of the pusher 25 and the cam inclined surface 242 of the final gear 24 is released when the final gear 24 rotates by a predetermined angle or more, the pusher 25 may move to the final gear 24 by the elastic force of the first elastic member and return to the original position.

The plurality of sensors 191, 192, and 193 of the sensor unit 19 opened by the shutter 28 may detect registration marks transferred to the transfer belt 151. The controller may determine whether a plurality of marks formed on the transfer belt 151 do not match the standard by detecting the width, length, etc. of a plurality of registration marks through the plurality of sensors 191, 192, and 193 of the sensor unit 19. When each mark formed on the transfer belt 151 corresponds to a preset ACR correction condition, the controller may control the exposure unit 12, the photoconductor 13, the developing unit 14, or the transfer unit 15 to perform correction on the color toner image formed on the transfer belt 151 and the print medium. In the ACR correction mode, the controller may control the paper feed roller 111 of the paper feed unit 11 not to rotate so that the print medium is not fed from the cassette unit 18.

When the ACR correction mode is completed, the controller may control the paper feed roller 111 of the paper feed unit 11 to rotate. The unlocking member 29 may rotate counterclockwise together with the paper feed roller 111 with reference to FIG. 11. The pressing protrusion 291 of the unlocking member 29 may press the locking protrusion 274 of the stopper 27 downward while rotating. In such an example, the locking protrusion 272 of the stopper 27 may be withdrawn from the locking groove 263 of the shutter link 26 while the stopper 27 rotates clockwise with respect to the second rotation shaft 271.

When the locking of the shutter link 26 is released, the shutter 28 may move from the second position to the first position by the third elastic member, and close the plurality of sensors 191, 192, and 193.

In some examples, the shutter device 20 may use the driving force of the mode switching motor 1541 included in the mode switching unit 154 without including a separate driving motor for driving the shutter 28, and omit a separate sensor for detecting the open/closed state of the shutter 28. Such examples may reduce manufacturing costs and secure a space for implementing various functions inside the main body 101 by omitting a separate motor and a separate sensor.

In some examples, in the case other than the ACR correction mode, the plurality of sensors 191, 192, and 193 of the sensor unit 19 may be maintained in the closed state through the shutter 28 of the shutter device 20, which may prevent the sensor unit 19 from being contaminated or may reduce a degree of contamination by the toner scattering in the main body 101 or the share of the print medium.

In examples herein, the gear chains 21, 23, and 24 may be described as receiving the driving force of the mode switching motor 1541, but examples are not limited thereto. For example, the gear chains 21, 23, and 24 may receive the driving force of one of driving motors provided in the image forming apparatus 1 in addition to the mode switching motor 1541 to drive the pusher 25. As an example, a paper feed motor for driving the paper feed roller 111 may be used as a power source of the pusher 25. In this example, at least one gear may be added so that the gear chains 21, 23, and 24 may be connected to a driving shaft of the paper feed motor, or to the contrary, the number of gears may be reduced.

The paper feed roller 111 may be set to rotate when the paper feed motor rotates in the forward direction and not rotate when the paper feed motor rotates in the reverse direction. Accordingly, when rotating the paper feed motor in the reverse direction, the gear chains 21, 23, and 24 may transmit the driving force of the paper feed motor to the pusher 25 to move the shutter 28 from the first position (e.g., the sensor closed position) to the second position (e.g., the sensor opened position). In this example, since the paper feed roller 111 does not rotate, the print medium may not be fed.

Conversely, when the paper feed motor rotates in the forward direction, the paper feed roller 111 may rotate and the unlocking member 29 may rotate therewith to drive the stopper 27. As locking of the shutter link 26 is released by the driving of the stopper 27, the shutter 28 may move from the second position (the sensor opened position) to the first position (the sensor closed position) and close the plurality of sensors 191, 192, and 193 of the sensor unit 19.

The present disclosure has been described above in an example manner. The terms used herein are for the purpose of description and should not be construed in a limiting sense. Various modifications and variations of the present disclosure are possible according to the above contents. Accordingly, unless otherwise stated, the present disclosure may be implemented freely within the scope of the claims.

1. A shutter device comprising:
a shutter;
a shutter link to move the shutter to a first position where an image quality calibration sensor is closed or a second position where the image quality calibration sensor is opened;
a pusher to press the shutter link to move the shutter to the second position; and
a power transmitting member to transmit a driving force provided inside an image forming apparatus to the pusher.

2. The shutter device of claim 1, wherein the shutter is moved from the second position to the first position in conjunction with rotation of a paper feed roller.

3. The shutter device of claim 1, wherein the power transmitting member receives a driving force from a mode switching unit for switching a printing mode.

4. The shutter device of claim 2, further comprising:
a stopper to lock the shutter link such that the shutter maintains the second position; and
an unlocking member to drive the stopper to unlock the shutter link locked by the stopper in conjunction with the rotation of the paper feed roller to move the shutter from the second position to the first position.

5. The shutter device of claim 1, wherein
the power transmitting member includes a plurality of gears, and
a final gear among the plurality of gears is in cam contact with the pusher to move the pusher in a linear direction.

6. The shutter device of claim 5, further comprising a first elastic member to elastically support the pusher in a direction from the second position to the first position.

7. The shutter device of claim 6, wherein:
the pusher is in cam contact with the final gear in a first rotation angle range of the final gear to press the shutter link in a direction from the first position to the second position;
the pusher is released from a cam contact with the final gear in a second rotation angle range of the final gear; and
the pusher returns to an original position by the first elastic member.

8. The shutter device of claim 5, wherein:
the final gear includes a cam inclined surface formed in a spiral direction along a central axis; and
the pusher includes a cam protrusion moving along the cam inclined surface.

9. The shutter device of claim 4, wherein:
the shutter link includes a locking groove to which a part of the stopper is inserted and detachably coupled; and
the stopper includes a locking protrusion detachably inserted into the locking groove of the shutter link.

10. The shutter device of claim 9, wherein the stopper includes a rotation shaft rotating in a first rotation direction in which the locking protrusion is inserted into the locking groove or a second rotation direction in which the locking protrusion is separated from the locking groove.

11. The shutter device of claim 10, comprising a second elastic member to elastically support the stopper in the first rotation direction.

12. The shutter device of claim 10, wherein:
the unlocking member rotates the stopper in the second rotation direction to separate the locking protrusion inserted into the locking groove from the locking groove in conjunction with a paper feed roller; and
the stopper includes a different groove into which a pressing protrusion provided on the unlocking member is inserted and having a part pressed by the pressing protrusion.

13. The shutter device of claim 1, further comprising a third elastic member to elastically support the shutter in a direction in which the shutter moves from the first position to the second position.

14. An image forming apparatus comprising:
a photoconductoron which an electrostatic latent image is formed;
a developing unit to supply a toner to the electrostatic latent image to form a toner image on a printing paper;
a sensor to detect a mark on a transfer belt for color image quality calibration; and
a shutter device to open and close the sensor, wherein the shutter device comprises:
a shutter;
a shutter link to move the shutter to a first position where the sensor is closed or a second position where the sensor is opened;
a pusher to receive power for mode switching from a transfer unit to press the shutter link so that the shutter moves to the second position; and
a power transmitting member to transmit a driving force provided inside an image forming apparatus to the pusher.

15. The image forming apparatus of claim 14, wherein the shutter device moves the shutter from the second position to the first position in conjunction with rotation of a paper feed roller.
